(19) United States
(12) Patent Application Publication
(10) Pub. No.: US 2005/0195977 A1
(43) Pub. Date: Sep. 8, 2005

(54) Semiconductor memory apparatus

(76) Inventor: Jean-Marc Dortu, Munchen (DE)

Correspondence Address: MOSER, PATTERSON & SHERIDAN, LLP;GERO G. MCCLELLAN/INFINEON, 3040 POST OAK BLVD.,, SUITE 1500, HOUSTON, TX, 77056, US

(21) Appl. No.: 11/068,594

(22) Filed: Feb. 28, 2005

(30) Foreign Application Priority Data
Feb. 27, 2004 (DE) DE 10 2004 009 69

(51) Int. Cl. H04N 7/167

(52) U.S. Cl. 380/218

(57) ABSTRACT

One embodiment of the invention provides a semiconductor memory apparatus comprising: a multiplicity of memory cells which are arranged in the manner of a matrix at least in regions, a multiplicity of address contacts for receiving a row address and/or column address for at least one memory cell, at least one address decoder for decoding the row and/or column addresses, and a descrambling device which is arranged in the electrical signal path between the address contacts and the address decoder. The descrambling device comprises address inputs for accepting input address bits of an input address which are received via the address contacts and address outputs for outputting output address bits of an output address to the address decoder. In a descrambling mode, the descrambling device is designed to allocate an output address bit explicitly to each input address bit of a received, scrambled row and/or column address such that the output address is the same as the unscrambled address. The descrambling device further comprises, for each output address bit, an allocation device for allocating the output address bit to a corresponding input address bit. The allocation devices of all output address bits may have the same design.

### CROSS-REFERENCE TO RELATED APPLICATIONS

This application claims foreign priority benefits under 35 U.S.C. §119 to co-pending German patent application number DE 10 2004 009 692.9-55, filed 27 Feb. 2004. This related patent application is herein incorporated by reference in its entirety.

### BACKGROUND OF THE INVENTION

1. Field of the Invention

The present invention relates to a semiconductor memory apparatus.

2. Description of the Related Art

When a dynamic random access memory (DRAM) is stacked with or onto another electronic component, the apparatuses connected in this manner generally share the same address bus and the same data bus. Generally, the address bits and the data bits can be scrambled or renamed or their order can be altered to adapt the data buses in a simple manner. By way of example, the individual bits of a row address or of a column address in a DRAM can be scrambled or interchanged with one another as desired or at random to simplify or permit the layout of the redistribution layer or the bonding. At the system level, the scrambling performed has no influence. When transmitting particular commands, however, it is necessary for the actual address produced by the processor or controller to be known in the semiconductor memory apparatus. The transmitted address bits therefore need to be “unscrambled” again.

It is known practice to provide a processor with processing in which, for particular commands or command sequences, the individual bits in this command sequence are present in a semiconductor memory apparatus in the actual arrangement or order produced by the processor. The multiplicity of possible semiconductor memory apparatuses which can be used with a processor means that it is a very complex matter to provide a suitable implementation for the possible semiconductor memory apparatuses in the processor.

Therefore, there is a need to provide a semiconductor memory apparatus which provides a simple way of descrambling or unscrambling received bits in a command sequence.

### SUMMARY OF THE INVENTION

One embodiment of the invention provides a semiconductor memory apparatus, comprising:
a multiplicity of memory cells which are arranged in the manner of a matrix at least in regions;
a multiplicity of address contacts for receiving a row address and/or column address for at least one memory cell;
at least one address decoder for decoding the row and/or column addresses; and
a descrambling device which
   is arranged in the electrical signal path between the address contacts and the address decoder,
   comprises address inputs for accepting input address bits of an input address which are received via the address contacts and address outputs for outputting output address bits of an output address to the address decoder, and
   is designed so as, in a descrambling mode, to allocate an output address bit explicitly to each input address bit of a received, scrambled row and/or column address such that the output address is the same as the unscrambled address,

wherein the descrambling device comprises, for each output address bit, an allocation device for allocating or connecting the output address bit to a corresponding input address bit, wherein the allocation devices of essentially all output address bits are of essentially the same design.

In particular, the descrambling device is designed such that, in the descrambling mode, each input address bit is explicitly allocated an output address bit such that the output address is the same as the address which is output by a processor device.

Address bits, in particular the individual positions in an address, may be received in parallel via the address inputs of a semiconductor memory apparatus.

A scrambled address is, in particular, an address in which the order or arrangement of the address bits, which may be transmitted in parallel, has been altered. In a scrambled address, the arrangement, in particular, of address bits, which may be transmitted in parallel, with respect to one another is different than an arrangement of such address bits as those produced by a processor device, for example. An unscrambled or descrambled address is, in particular, an address in which the arrangement or order of the parallel-transmitted bits with respect to one another is the same as the arrangement or order of the address bits which have been produced by a processor device. An unscrambled address therefore corresponds to an address before it is subjected to a scrambling operation.

The allocation of input address bits to output address bits and vice versa means, in particular, that the position of an address bit in an input address is assigned to the same or to a different position in the output address according to a predetermined descrambling pattern.

The descrambling device may also have a normal operation mode in which the received address bits are essentially subjected to no processing and are “looped” through the descrambling device. In the descrambling device's normal operating mode, the output address bits thus correspond essentially to the input address bits.

The number of input address bits may be the same as the number of output address bits. The number of allocation devices may be the same as the number of bits in an address which is to be processed.

In one embodiment, all of the allocation devices are of the same design when the semiconductor memory apparatus is fabricated. The descrambling device can be matched to the respective processor device or to the respective transmission bus, which the semiconductor memory apparatus uses for communication, at a later time. By way of example, such matching can be performed during a test on the semiconductor memory apparatus. In particular, this may involve stipulating the respective descrambling method or stipulating the allocation of the input address bits to the output address bits. It is thus advantageously possible to simplify the fabrication method for the semiconductor memory apparatus, since it is not necessary to provide a particular semiconductor memory apparatus for each different scrambling operation.

The allocation devices each may have a signal connection to an address output and to all address inputs. Furthermore, the allocation devices also each may comprise a selection device for selecting an input address bit which needs to be allocated to the respective output address bit.

Thus, it is a simple matter to produce an association between an output address bit and an input address bit. In particular, the form of the descrambling device allows such an allocation to be made at a later time than the fabrication time.

In one embodiment, each selection device comprises a number of outputs which corresponds to the number of bits or positions in the address, a respective output being associated with an input address bit, and the selection devices are in a form such that, during operation, a predetermined selection signal is transmitted only via that output which is associated with the input address bit which needs to be allocated to the respective output address bit.

The 1:1 association between the outputs of the selection device and the input address bits makes it a simple matter to select that input address bit which needs to be allocated to the respective output address bit. Those outputs which are associated with input address bits that do not need to be allocated to the respective output address bit may be utilized to transmit a signal which is the logic complement of the predetermined selection signal.

The selection device may be also in a form such that the predetermined selection signal is transmitted just via a single output. Furthermore, the multiplicity of selection devices provided in a descrambling device may be in a form such that they are each in different forms than one another in the standby state.

In one embodiment, the selection device comprises a number of fuses which corresponds to the number of bits in the address, a respective fuse having a signal connection to an output on the selection device.

A respective fuse is thus associated with an input address bit. Particular forms for the respective fuses makes it a simple matter to select that input address bit which needs to be allocated to the respective output address bit. To this end, preferably during a test on the semiconductor memory apparatus, that fuse is destroyed which is associated with the input address bit which needs to be allocated to the output address bit. Destroying the fuse makes it possible for the allocated output of the selection device to produce, during operation of the semiconductor memory apparatus, a signal which is different than (e.g., complementary to) the signal which is at the other outputs of the selection device.

Alternatively, the selection device comprises a number of fuses to provide binary coding for the number of bits in an address and a selection decoder which has a signal connection to the fuses and which has a number of outputs corresponding to the number of bits in the address. The outputs of the selection decoder have a signal connection to the outputs of the selection device, and the selection decoder is in a form such that the output which corresponds to the input address bit that needs to be allocated to the respective output address bit is used to output a selection signal on the basis of the signals which are applied to the fuses.

In particular, the number of fuses corresponds to the base 2 logarithm (rounded up to an integer) of the number of bits in an address. Expressed another way, the number of fuses corresponds to the value (respectively rounded, up to an integer) of ld(n) or log₂(n), where n corresponds to the number of bits in an address. Preferably, exactly the same number of fuses is used as is needed for providing binary coding for the number of address bits.

Hence, the binary coding by the fuses and the subsequent decoding by the selection decoder can be used to select one of the input address bits which needs to be allocated to the output address bit. In particular, the selection decoder uses just one output to output the predetermined selection signal. The other outputs are then used to output a signal which is the complement thereof.

To this end, preferably during a test on the semiconductor memory apparatus, none, one or a plurality of the fuses is/are destroyed to produce the binary coding.

The allocation devices each may also comprise: an initial circuit or input circuit which has a signal connection at least to the first input address bit, a final circuit or output circuit which has a signal connection at least to the last input address bit, and at least one central circuit, with each central circuit having a signal connection at least to one of the remaining or central input address bits, and all of the central circuits being of essentially the same design.

The first input address bit may be the input address bit which is transmitted via the first address contact from the address contacts, which may be consecutively numbered in ascending order. The last input address bit may be the input address bit which is transmitted via the last address contact. The remaining or central input address bits are those input address bits which are received neither via the first nor via the last address contact.

The allocation devices are thus constructed from three, possibly multiple-instance circuits. The input circuit and the output circuit are each in separate form. The form of the initial circuit, final circuit and of the central circuits is independent of the number of bits in an address. In particular, just the number of central circuits varies with the number of bits in an address. In particular, a respective central circuit is provided per central input address bit. In this context, the central circuits are all in the same form.

In one embodiment, the initial circuit, the final circuit and the central circuit(s) each have a signal connection to an output on the selection device.

Furthermore, the initial circuit, the central circuit(s) and the final circuit may have a signal connection to one another.

Moreover, a first central circuit may have a signal connection to the signal output of the initial circuit; the subsequent central circuits have a signal connection to the signal output of the respective preceding central circuit; the final circuit has a signal connection to the signal output of the last central circuit; and the signal output of the final circuit has a signal connection to the respective address output of the descrambling device.

The initial circuit, the final circuit and the central circuits perform logic operations, with the result of a preceding logic operation in one of the circuits being used as input for the logic operation in a subsequent circuit. During operation of the semiconductor memory apparatus, the signal output of the final circuit may produce the respective input address bit associated with the output address bit.

The semiconductor memory apparatus may also comprise a control input for accepting a control signal which can be used to select the descrambling mode.

By transmitting a control signal to the semiconductor memory apparatus, it is thus possible to stipulate whether the semiconductor memory apparatus needs to descramble the received address bits or whether the address bits can be processed further as received.

The descrambling device may be in a form such that the descrambling mode is used when a configuration command or a configuration command sequence is transmitted to the semiconductor memory apparatus.

In one embodiment, the configuration command is a mode register set command (or MRS command) which can be used to determine, by way of example, the operating mode, the burst type, the burst length, the CAS latency, the type of operation, etc., of the semiconductor memory apparatus. The configuration command can be used to program the semiconductor memory apparatus. The configuration command may be sent at least at the start of operation of the semiconductor memory apparatus. Transmission of the configuration command also involves the use of the address bits or address contacts of a semiconductor memory apparatus. However, in contrast to read or write commands, where it makes essentially no difference to which memory cell data are written or whether the address of this memory cell is scrambled, it is of great importance for configuration commands that the information which the address bits contains is present in the semiconductor memory apparatus in unscrambled form, i.e., corresponds to that arrangement which has been produced by the processor device.

In one embodiment, the descrambling device is designed as part of the address decoder.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a highly schematic view of a semiconductor memory apparatus according to one embodiment of the present invention;

FIG. 2 shows a highly schematic view of a descrambling device in the semiconductor memory apparatus shown in FIG. 1;

FIG. 3 shows a schematic view of a descrambling device according to a first embodiment of the present invention;

FIG. 4 shows a schematic view of an allocation device in the descrambling device shown in FIG. 3;

FIG. 5 shows a schematic view of a first exemplary form of an allocation device according to the first embodiment of the present invention;

FIG. 6 shows a schematic view of a second exemplary form of an allocation device according to the first embodiment of the present invention;

FIG. 7 shows a schematic view of a descrambling device according to a second embodiment of the present invention;

FIG. 8 shows a schematic view of a selection device which is used in the descrambling device shown in FIG. 7; and

FIG. 9 shows a schematic view of a selection decoder which is used in the selection device shown in FIG. 8.

### DETAILED DESCRIPTION OF THE PREFERRED EMBODIMENT

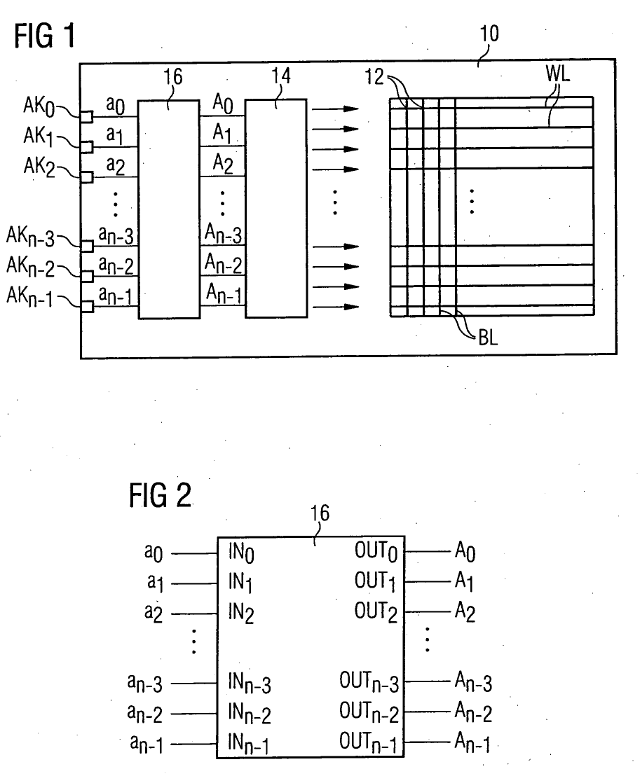

First, the design of a semiconductor memory apparatus 10 according to one embodiment of the present invention is described with reference to FIGS. 1 and 2.

The semiconductor memory apparatus 10 comprises a multiplicity of memory cells 12 which are arranged in the manner of a matrix and which can be addressed via word lines WL and bit lines BL. The semiconductor memory apparatus 10 also comprises an address decoder 14 which decodes a received row address or column address and activates the corresponding word line WL or bit line BL. In the embodiment shown, just one address decoder 14 for the row addresses is shown, for reasons of clarity. A corresponding address decoder may also be provided for decoding the column addresses, however.

In addition, the semiconductor memory apparatus 10 contains a descrambling device 16, as illustrated in FIG. 2. The descrambling device 16 comprises a multiplicity of address inputs IN₀ . . . INₙ₋₁ and a corresponding number of address outputs OUT₀ . . . OUTₙ₋₁. The address inputs IN₀ . . . INₙ₋₁ can be used for inputting input address bits a₀ . . . aₙ₋₁ of an address which has been input into the semiconductor memory apparatus 10, e.g., a row or column address, into the descrambling device 16. The address outputs OUT₀ . . . OUTₙ₋₁ are used for outputting output address bits A₀ . . . Aₙ₋₁. The descrambling device 16 is in a form such that, during operation of the semiconductor memory apparatus 10, for example, when the latter is in a descrambling mode, an output address bit A₀ . . . Aₙ₋₁ may be allocated explicitly to each input address bit a₀ . . . aₙ₋₁ according to a prescribed pattern (described in detail later). The number of address inputs IN₀ . . . INₙ₋₁, and hence the number of input address bits a₀ . . . aₙ₋₁ is equal to the number of address outputs OUT₀ . . . OUTₙ₋₁, and hence to the number of output address bits A₀ . . . Aₙ₋₁.

In addition, the semiconductor memory apparatus 10 comprises address contacts AK₀ . . . AKₙ₋₁ which can be used to input addresses into the semiconductor memory apparatus 10. The address contacts AK₀ . . . AKₙ₋₁ have a signal connection to the address inputs IN₀ . . . INₙ₋₁ of the descrambling device 16. Furthermore, the address outputs OUT₀ . . . OUTₙ₋₁ of the descrambling device 16 each have a signal connection to inputs on the address decoder 14.

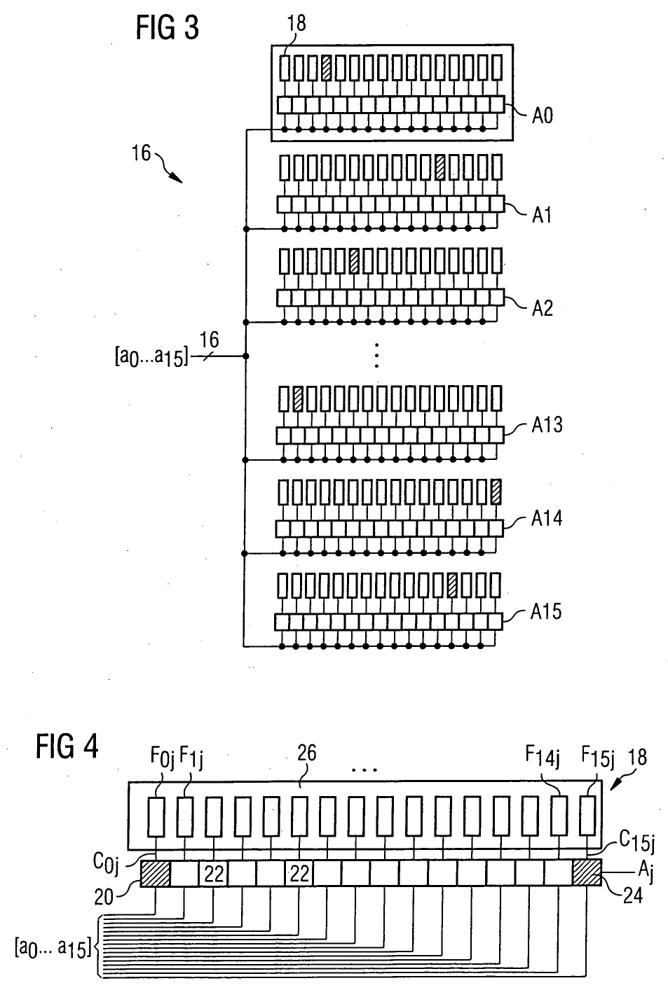

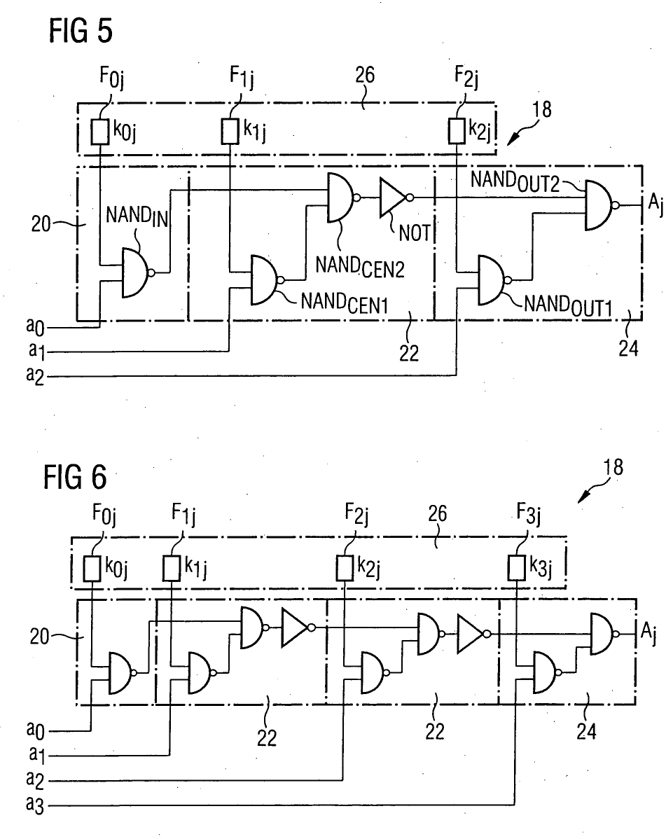

A descrambling device 16 according to a first embodiment of the present invention is described below with reference to FIGS. 3-6. In this context, FIG. 3 shows a schematic view of a descrambling device according to a first embodiment of the present invention. FIG. 4 shows a schematic view of an allocation device in the descrambling device shown in FIG. 3. FIG. 5 shows a schematic view of a first exemplary form of an allocation device according to the first embodiment of the present invention. FIG. 6 shows a schematic view of a second exemplary form of an allocation device according to the first embodiment of the present invention.

The descrambling device 16 according to the first embodiment of the present invention comprises a multiplicity of allocation devices 18. In the embodiment shown, one allocation device 18 is provided for each bit or for each position a₀ . . . aₙ₋₁ in a parallel-transmitted input address, for example. In the embodiment shown, an address has n=16 bits. There are thus 16 allocation devices 18.

An allocation device 18 is used to allocate an input address bit aᵢ explicitly to an output address bit Aⱼ. This means, in particular, that an input address bit aᵢ, which is at the position i in the input address, is allocated to an output address bit Aⱼ, and is thus at the position j in the output address.

FIG. 4 shows a detailed view of an allocation device 18 for allocating an input address aᵢ to an output address bit Aⱼ. The allocation device 18 comprises an initial circuit 20, a plurality of central circuits 22 and a final circuit 24.

In addition, the allocation device 18 comprises a selection device 26 which comprises a multiplicity of outputs C₀ⱼ . . . C₁₅ⱼ. In the allocation device 18 shown in FIG. 4, according to the first embodiment of the present invention, the selection device 26 comprises a multiplicity of fuses F₀ⱼ . . . F₁₅ⱼ. In this context, each fuse F₀ⱼ . . . F₁₅ⱼ has a signal connection to an output C₀ⱼ . . . C₁₅ⱼ. The outputs C₀ⱼ . . . C₁₅ⱼ are respectively used to transmit selection signals k₀ⱼ . . . k₁₅ⱼ.

A respective output C₀ⱼ . . . C₁₅ⱼ on the selection device 26 has a signal connection to one of the circuits 20, 22, 24. In particular, the first output C₀ⱼ has a signal connection to the initial circuit 20; the central outputs C₁ⱼ . . . C₁₄ⱼ each have a signal connection to a central circuit 22; and the last output C₁₅ⱼ has a signal connection to the final circuit 24.

In addition, the initial circuit 20 has a signal connection to the first input address bit a₀; the central circuits 22 each have a signal connection to the central input address bits a₁ . . . a₁₄; and the final circuit 24 has a signal connection to the last input address bit a₁₅. Furthermore, the final circuit 24 has a signal connection to an address output OUTⱼ which is used to output an output address bit Aⱼ.

The above-described basic design of the allocation device 18 may be the same for all of the allocation devices 18 shown in FIG. 3. Furthermore, all of the central circuits 22 may have the same design.

In order to allow descrambling or unscrambling, just one fuse Fᵢⱼ of an allocation device 18 is respectively destroyed (e.g., burned by laser). Hence, that output Cᵢⱼ of the allocation device 18 which has a signal connection to this destroyed fuse Fᵢⱼ is used to output a selection signal kᵢⱼ which is the complement of the signal which is output via the other outputs. As a result, the respective input address bit aᵢ can be selected and allocated to the respective output address bit Aⱼ. The selected input address bit aᵢ is, in particular, that bit which is associated with the destroyed fuse Fᵢⱼ.

In the arrangement shown in FIG. 3, a respective different fuse Fᵢⱼ has been destroyed in each allocation device 18 shown. Hence, each output address bit A₀ . . . A₁₅ is allocated a different input address bit a₀ . . . a₁₅. The signal or the output address bit Aⱼ which is at an address output OUTⱼ can thus be represented using equation (1) below.
Aⱼ=k₀ⱼ·a₀+kᵢⱼ·a₁+ . . . +kᵢⱼ·aᵢ+ . . . +k₍ₙ₋₁₎ⱼ·a₍ₙ₋₁) Equation (1)

In this context, k₀ⱼ . . . k₍ₙ₋₁₎ⱼ corresponds to the respective signal which is transmitted via the respective output C₀ⱼ . . . C₍ₙ₋₁₎ⱼ of the selection device. For each output address bit Aⱼ, precisely one kᵢⱼ assumes the logic value 1, whereas all other k assume the logic value 0. In this way, the output address bit Aⱼ is allocated the input address bit aᵢ.

FIG. 5 shows a more detailed form of the allocation device 18 shown in the FIG. 4. For representation reasons, the present case provides an example having just three input address bits A₀ . . . A₂.

In this context, the initial circuit 20 comprises a NAND gate NAND_{IN}, the first input address bit a₀ and the signal k₀ⱼ being used as input for the gate NAND_{IN}.

The central circuit 22 comprises two NAND gates, i.e., NAND_{CEN1} and NAND_{CEN2}. The input of the gate NAND_{CEN1} has a signal connection to the central input address bit a₁ and to the signal k₁ⱼ. The input of the second gate NAND_{CEN2} has a signal connection to the output of the first gate NAND_{CEN1} and to the output of the gate NAND_{IN} of the initial circuit 20. The output of the gate NAND_{CEN2} is logically inverted by means of a gate NOT.

The final circuit 24 comprises two NAND gates NAND_{OUT1} and NAND_{OUT2}. The input of the gate NAND_{OUT1} has a signal connection to the last input address bit a₂ and to the signal k₂ⱼ. The inputs of the gate NAND_{OUT2} have a signal connection to the output of the first gate NAND_{OUT1} and to the signal from the central circuit 22, which signal has been inverted by the gate NOT. The signal output of the gate NAND_{OUT2} then produces the output address bit Aⱼ.

Depending on which of the fuses f₀ⱼ . . . f₂ⱼ has been destroyed and hence which respective signal k₀ⱼ . . . k₂ⱼ has the logic value 1, the gates in the initial circuit 20, central circuit 22 and final circuit 24 switch such that the respective input address bit aᵢ associated with the destroyed fuse is at the output Aⱼ.

This can be expressed by the equations (3.1) and (3.2) below.

$$\begin{matrix}{A}_{j} = {a}_{0} \cdot {k}_{0 j} + {a}_{1} \cdot {k}_{1 j} + {a}_{2} \cdot {k}_{2 j} = \overline{\overline{( {a}_{0} \cdot {k}_{0 j} )} \cdot \overline{( {a}_{1} \cdot {k}_{1 j} )} \cdot \overline{( {a}_{2} \cdot {k}_{2 j} )}} & Equation ( 3.1 ) \\ {A}_{j} = {a}_{0} \cdot {k}_{0 j} + {a}_{1} \cdot {k}_{1 j} + {a}_{2} \cdot {k}_{2 j} = \overline{\overline{\overline{( \overline{( {a}_{0} \cdot {k}_{0 j} )} \cdot \overline{( {a}_{1} \cdot {k}_{1 j} )} )}} \cdot \overline{( {a}_{2} \cdot {k}_{2 j} )}} & Equation ( 3.2 )\end{matrix}$$

FIG. 6 shows a further example of the allocation device 18 shown in FIG. 5. In this context, four address bits are provided. The allocation device 18 shown is of essentially the same design as the allocation device 18 shown in FIG. 5. The difference in this context is that two central circuits 22 are provided for the two central input address bits a₁ and a₂. The two central circuits shown in FIG. 6 may have the same design as the central circuit 22 shown in FIG. 5. For this reason, a detailed description thereof is omitted.

As shown in FIG. 6, the signal which is on the output address bit Aⱼ can be expressed using the equations (4.1) and (4.2).

$$\begin{matrix}{A}_{j} = {a}_{0} \cdot {k}_{0 j} + {a}_{1} \cdot {k}_{1 j} + {a}_{2} \cdot {k}_{2 j} + {a}_{3} \cdot {k}_{3 j} = \overline{\overline{( {a}_{0} \cdot {k}_{0 j} )} \cdot \overline{( {a}_{1} \cdot {k}_{1 j} )} \cdot \overline{( {a}_{2} \cdot {k}_{2 j} )} \cdot \overline{( {a}_{3} \cdot {k}_{3 j} )}} \\ & Equation ( 4.1 ) \\ {A}_{j} = {a}_{0} \cdot {k}_{0 j} + {a}_{1} \cdot {k}_{1 j} + {a}_{2} \cdot {k}_{2 j} + {a}_{3} \cdot {k}_{3 j} = \overline{\overline{\overline{[ \overline{\overline{( \overline{( {a}_{0} \cdot {k}_{0 j} )} \cdot \overline{( {a}_{1} \cdot {k}_{1 j} )} )}} \cdot \overline{( {a}_{2} \cdot {k}_{2 j} )} ]}} \cdot \overline{( {a}_{3} \cdot {k}_{3 j} )}} & Equation ( 4.2 )\end{matrix}$$

In order to provide an allocation device 18 having 16 address bits as shown in FIG. 4, an appropriate number of central circuits 22 are interconnected as appropriate. In this context, the number of central circuits 22 used is two lower than the total number of address bits, or is equal to n-2, where n is the total number of address bits.

In the embodiment described above, n fuses are needed for each allocation device 18, and n allocation devices 18 are needed per descrambling device 16. The total number of fuses required is thus n*n=n².

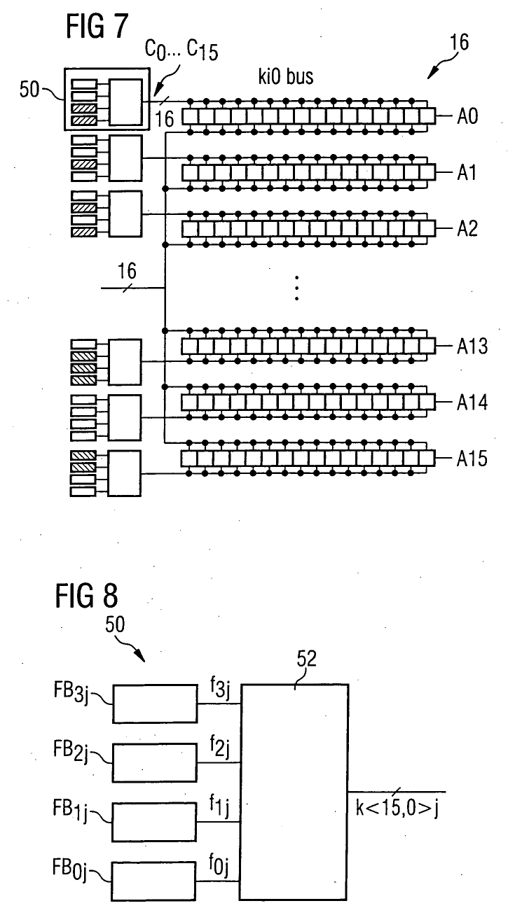

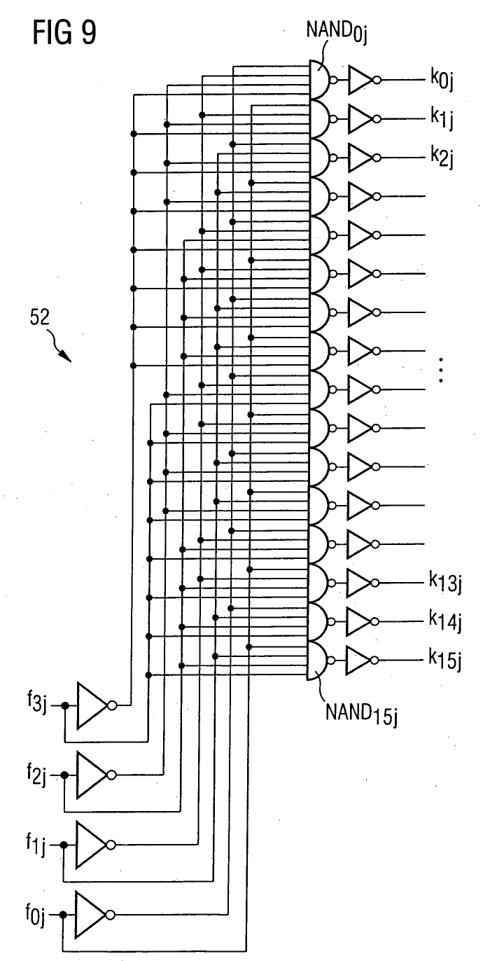

A second embodiment of a descrambling device 16 is described below with reference to FIGS. 7-9. In this context, FIG. 7 shows a schematic view of a descrambling device according to a second embodiment of the present invention; FIG. 8 shows a schematic view of a selection device which is used in the descrambling device shown in FIG. 7; and FIG. 9 shows a schematic view of a selection decoder which is used in the selection device shown in FIG. 8.

The descrambling device 16 shown may have essentially the same design as the descrambling device 16 according to the first embodiment. However, the selection device is in a different form. For this reason, a detailed description of the elements which are common to the first and second embodiments is omitted below.

Like the selection device 26 according to the first embodiment, the selection device 50 has a multiplicity of outputs C₀ⱼ . . . C₁₅ⱼ. This is shown in FIGS. 7 and 8 as a contact with an output bus Kᵢ₀ bus.

The selection device 50 comprises a plurality of fuses FB₀ⱼ . . . FB₃ⱼ which are used for providing binary coding for the number i of the input address bit Aᵢ. To this end, none, one or a plurality of the fuses FB₀ⱼ . . . FB₃ⱼ is/are destroyed. Depending on which of fuses FB₀ⱼ . . . FB₃ⱼ has/have been destroyed, a different coding is obtained.

The number of fuses FB₀ⱼ . . . FB₃ⱼ used corresponds to the base 2 logarithm (rounded up to an integer) of the number of bits in an address. Expressed another way, the number of fuses corresponds to the value (respectively rounded up to an integer) of the ld(n) or log₂(n), where n corresponds to the number of bits in an address. In one embodiment, exactly the same number of fuses are used as are required for providing binary coding for the number of address bits. In the embodiment shown, an address has 16 bits. Hence, ld(16)=4 fuses are required.

In addition, the selection device 50 has a selection decoder 52 which has a signal connection to the fuses FB₀ᵢ . . . FB₃ᵢ. In this context, the signals f₀ᵢ . . . f₃ᵢ are used as inputs for the selection decoder 52. The selection decoder 52 takes the binary coding and determines that input address bit aᵢ which needs to be allocated to the respective output address bit Aⱼ.

A selection decoder 52 (shown generally in the selection device 50 shown in FIG. 8) is shown in detail in FIG. 9.

In the logic circuit shown, all signals f₀ⱼ . . . f₃ⱼ are respectively supplied to NAND gates NAND₀ⱼ . . . NAND₁₅, with the signals f₀ⱼ . . . f₃ⱼ being inverted and not inverted in different combinations. In this context, a number of NAND gates NAND₀ⱼ . . . NAND₁₅ⱼ which corresponds to the number of address bits is provided. In other words, the input of each of the gates NAND₀ⱼ . . . NAND₁₅ⱼ shown respectively has all of the signals f₀ⱼ . . . f₃ⱼ applied to it, with the signals f₀ⱼ . . . f₃ⱼ not being inverted, being inverted at least in part or all being inverted. In particular, the form of the interconnection achieves all possible combinations of inverted and non-inverted signals.

The output signals from the gates NAND₀ⱼ . . . NAND₁₅ⱼ are inverted. The resultant signal corresponds to the signals k₀ⱼ . . . k₁₅ⱼ in the first embodiment. The form shown for the circuit makes it possible to achieve a situation in which just a single signal case k₀ⱼ . . . k₁₅ⱼ assumes the logic value “1”. Using these signals k₀ⱼ . . . k₁₅ⱼ, a respective input address bit aⱼ may be selected which needs to be allocated to the output address bit Aⱼ.

In the second embodiment described above, Id(n)*n fuses are required. The advantageous form according to the second embodiment thus allows the number of fuses required to be reduced in comparison with the first embodiment.

During fabrication of the semiconductor memory apparatus 10 described, the descrambling device 16 may be produced. The fuses may be “fused” or destroyed at a later time. In particular, it is advantageous if the fusing takes place while the semiconductor memory apparatus 10 is being tested. The form of the descrambling device 16 in the semiconductor memory apparatus 10 allows the respective descrambling pattern required for a particular application to be produced in the descrambling device when the application of the semiconductor memory apparatus 10 is stipulated.

Provision may also be made for the descrambling devices 16 described to contain a bypass (not shown) which may be used to bypass the circuit arrangements described. In addition, the semiconductor memory apparatus 10 may contain a control input (not shown) which may be used to receive a control signal. Such a control signal may be used to select various operating modes of the semiconductor memory apparatus 10 or of the descrambling devices 16. In this context, at least one normal operating mode and a descrambling mode may be provided. During the descrambling mode, the descrambling device 16 is active, i.e., appropriate descrambling is performed. During the normal operating mode, the bypass is active, and no descrambling takes place.

In one embodiment, the descrambling mode is used when a configuration command or a configuration command sequence is transmitted to the semiconductor memory apparatus 10. The configuration command may be a mode register set command (or MRS command). The MRS command may be used, in particular, to determine the burst length, the burst type, the CAS latency and a type of operation for the semiconductor memory apparatus 10. In this context, address bits are also used to program or configure the semiconductor memory apparatus 10.

The MRS command is sent from the processor unit to the semiconductor memory apparatus 10 at least once at the start of operation of the circuit arrangement. Programming the semiconductor memory apparatus 10 using the MRS command is typically a slow application.

The text above described the descrambling for address bits. However, it is likewise conceivable to provide appropriate descrambling for data bits.

While the foregoing is directed to embodiments of the present invention, other and further embodiments of the invention may be devised without departing from the basic scope thereof, and the scope thereof is determined by the claims that follow.

1. A semiconductor memory apparatus, comprising:
a plurality of memory cells arranged in a matrix;
a plurality of address contacts for receiving at least one of a row address and column address for at least one memory cell;
at least one address decoder for decoding the received at least one of the row address and the column address; and
a descrambling device arranged in the electrical signal path between the address contacts and the address decoder, comprising:
address inputs for accepting input address bits of an input address which are received via the address contacts;
address outputs for outputting output address bits of an output address to the address decoder, wherein the descrambling device is configured, in a descrambling mode, to allocate an output address bit explicitly to each input address bit of a received, scrambled address such that the output address is the same as an unscrambled address; and
for each output address bit, an allocation device for allocating the output address bit to the corresponding input address bit, wherein the allocation devices of all output address bits have substantially similar design.

2. The semiconductor memory apparatus of claim 1, where each allocation device has a signal connection to an address output and to all address inputs.

3. The semiconductor memory apparatus of claim 2, wherein each allocation device further comprises a selection device for selecting an input address bit which needs to be allocated to the respectively connected output address bit.

4. The semiconductor memory apparatus of claim 3, wherein each selection device comprises a plurality of outputs which corresponds to a number of bits in the input address, wherein a respective output is associated with the input address bit, and wherein the selection devices are configured such that, during operation, a predetermined selection signal is transmitted only via the respective output which is associated with the input address bit which needs to be allocated to the respective output address bit.

5. The semiconductor memory apparatus of claim 4, wherein each selection device comprises a number of fuses which corresponds to the number of bits in the address, each respective fuse having a signal connection to a respective output on the selection device.

6. The semiconductor memory apparatus of claim 4, wherein each selection device comprises:
a plurality of fuses to provide binary coding for the number of bits in the address; and
a selection decoder which has a signal connection to the fuses and which has a plurality of outputs which corresponds to the number of bits in the address, wherein the outputs of the selection decoder have a signal connection to the outputs of the selection device and wherein the selection decoder is configured such that the output which corresponds to the input address bit that needs to be allocated to the respective output address bit is utilized to output a selection signal on the basis of signals which are applied to the fuses.

7. The semiconductor memory apparatus of claim 1, wherein each allocation device further comprises:
an initial circuit having a signal connection at least to a first input address bit;
a final circuit having a signal connection at least to a last input address bit; and
at least one central circuit, each central circuit having a signal connection at least to one remaining input address bits, wherein all of the central circuits have substantially similar design.

8. The semiconductor memory apparatus of claim 7, wherein each of the initial circuit, the final circuit and the at least one central circuit has a respective signal connection to a respective output on the selection device.

9. The semiconductor memory apparatus of claim 8, where a signal connection connects the initial circuit, the at least one central circuit and the final circuit.

10. The semiconductor memory apparatus of claim 9,
wherein a first central circuit has a signal connection to the signal output of the initial circuit;
wherein one or more subsequent central circuits have a signal connection to the signal output of a respective preceding central circuit,
wherein the final circuit has a signal connection to the signal output of the last central circuit; and
wherein the signal output of the final circuit has a signal connection to a respective address output of the descrambling device.

11. The semiconductor memory apparatus of claim 1, further comprising a control input for accepting a control signal utilized to select the descrambling mode.

12. The semiconductor memory apparatus of claim 1, wherein the descrambling device is configured to activate the descrambling mode when a configuration command is transmitted to the semiconductor memory apparatus.

13. The semiconductor memory apparatus of claim 1, wherein the descrambling device is configured as part of the address decoder.

14. A semiconductor memory apparatus, comprising:
a plurality of memory cells arranged in a matrix addressable via a plurality of word lines and a plurality of bit lines;
a descrambling device connected to receive a scrambled input address, comprising:
a plurality of address inputs for accepting a plurality of input address bits of the scrambled input address;
a plurality of address outputs for a plurality of output address bits of a descrambled output address; and
for each output address bit, an allocation device for allocating each output address bit to a respective input address bit, wherein the descrambling device is configured, in a descrambling mode, to allocate each output address bit to the respective input address bit such that the descrambled output address is the same as an unscrambled input address; and
an address decoder connected to receive the descrambled address from the descrambling device, the address decoder configured to decode the descrambled address and activate at least one of a word line and a bit line corresponding to the decoded descrambled address.

15. The semiconductor memory apparatus of claim 14, wherein each allocation device comprises a selection device for selecting an input address bit which needs to be allocated to the respectively connected output address bit.

16. The semiconductor memory apparatus of claim 15, wherein the selection devices are configured such that, during operation, a predetermined selection signal is transmitted via the respective output address bit which is associated with the selected input address bit.

17. The semiconductor memory apparatus of claim 16, wherein each selection device comprises a plurality of fuses which corresponds to a number of bits in the address, each respective fuse having a signal connection to a respective output on the selection device.

18. The semiconductor memory apparatus of claim 15, wherein each allocation device further comprises:
an initial circuit having a signal connection at least to a first input address bit;
a final circuit having a signal connection at least to a last input address bit; and
a plurality of central circuits, each central circuit having a signal connection one remaining input address bit, wherein all of the central circuits have substantially similar design and wherein each of the initial circuit, the final circuit and the central circuits has a respective signal connection to a respective output on the selection device.

19. A method for operating a semiconductor memory apparatus, comprising:
receiving a scrambled input address via a descrambling device, the descrambling device comprising:
a plurality of address inputs for accepting a plurality of input address bits of the scrambled input address;
a plurality of address outputs for a plurality of output address bits of a descrambled output address; and
for each output address bit, an allocation device for allocating each output address bit to a respective input address bit;
allocating each output address bit to the respective input address bit such that the descrambled output address is the same as an unscrambled input address; and
receiving, by an address decoder, the descrambled address from the descrambling device;
decoding the descrambled address; and
activating at least one of a word line and a bit line for a matrix of memory cells, the at least one of the world line and the bit line corresponding to the decoded descrambled address.

20. The method of claim 19, wherein each allocation device comprises a selection device, and further comprising:
selecting, utilizing the respective selection device, an input address bit which needs to be allocated to the respectively connected output address bit.
